(19) United States
(12) Patent Application Publication
(10) Pub. No.: US 2014/0157238 A1
(43) Pub. Date: Jun. 5, 2014

(54) SYSTEMS AND METHODS OF ASSESSING SOFTWARE QUALITY FOR HARDWARE DEVICES

(71) Applicant: MICROSOFT CORPORATION, Redmond, WA (US)

(72) Inventors: Dimitar Popov, Redmond, WA (US); Herman Widjaja, Sammamish, WA (US); Sergey Fokin, Redmond, WA (US); Ahmed Zakaria Mohamed, Bellevue, WA (US); Todd Frost, Woodinville, WA (US); Kam Ming Chui, Bellevue, WA (US)

(73) Assignee: MICROSOFT CORPORATION, Redmond, WA (US)

(21) Appl. No.: 13/691,393

(22) Filed: Nov. 30, 2012

(51) Int. Cl. G06F 11/36

(52) U.S. Cl. CPC G06F 11/3668
USPC 717/126

(57) ABSTRACT

Systems and techniques of monitoring, assessing and determining the quality of software components and/or their associated features that may be designed and built to be run on a plurality of hardware devices. Such hardware devices may be devices made by different manufacturers. In addition, certain of these manufacturers may be device partners with the software maker. Software product and/or components may be subjected to test runs on various hardware devices and the results may be correlated. This pass/fail data may also be correlated against a number of additional factors—e.g., the market share of device products for which a software product has a minimum level of acceptable or passing rates.

### BACKGROUND

In the area of software design, it is typically desirable to design the software to work with a number of various hardware devices and/or platforms. For one paradigm example, this is particularly the case for the consumer market that involves smart phones, tablets, game consoles and various displays.

For software designers that desire that their software work on multiple hardware platforms, there are a number of challenges. For one such challenge, it may be desirable to create a representative set of different devices on which tests will be performed. The criteria for device selection might be based on device popularity, partner and business strategies, etc.

In addition, it may be desirable to examine and evaluate the results of such tests in order to make a business decision, assign resources, etc. in order to adroitly address market desires and needs with timely and functional software.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and techniques of monitoring, assessing and determining the quality of software components and/or their associated features that may be designed and built to be run on a plurality of hardware devices. Such hardware devices may be devices made by different manufacturers. In addition, certain of these manufacturers may be device partners with the software maker. Software product and/or components may be subjected to test runs on various hardware devices and the results may be correlated. This pass/fail data may also be correlated against a number of additional factors—e.g., the market share of device products for which a software product has a minimum level of acceptable or passing rates.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts one embodiment of system for the processing of data regarding the functionality and quality level and/or issues of software components that are built and meant to be run on hardware devices.

FIGS. 2 through 6 depict various aspects of a processing module that assesses software quality against a number of possible hardware devices and possible features.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Introduction

Several embodiments of the present application provide a systems and methods for collecting and analyzing hardware devices data and correlate it with test results. In many of the following embodiments, some possible aspects of these embodiments may comprise: (1) collect, process and analyze market share, usage and capabilities data for different types of hardware devices; (2) represent the device data in various forms and reports; (3) collect, process and analyze the results of various tests performed on the devices; and (4) correlate the test results and the device data to allow making of informed business decisions.

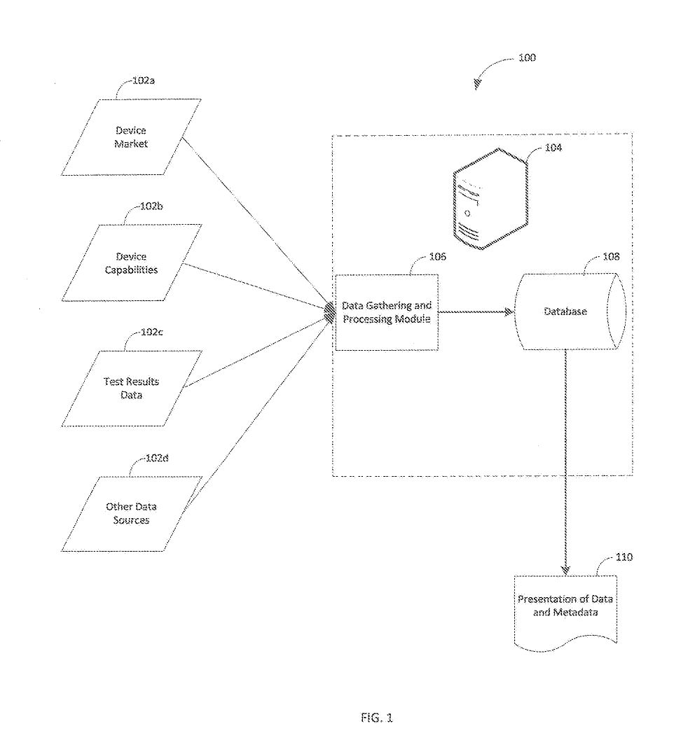

FIG. 1 depicts one possible embodiment of system 100 as made according to the principles of the present application. System 100 may comprise a processor 104—which may further comprise a data gathering and processing module 106 and/or a database 108. As will be discussed further herein, system 100 may input data from a number of data sources—e.g., data market data 102a, device capabilities 102b, test result data 102c and other data sources 102d. As will be described herein, these data may be input into system 104 by a variety of means—e.g., wired, wireless or the like—and in a variety of formats—e.g., digital and/or analog.

This data may be gathered and processed in module 106 and both intermediate and/or final data may be stored in an electronic storage—e.g., database 108, RAM, ROM or the like.

In many of the embodiments, system 100 may be configured to correlate the results of the testing of software components (e.g., drivers or the like) that may be designed to run on a variety of hardware devices. Oftentimes, management of such software builds would desire to have timely access to test data results on software that may be built to run on a variety of similar hardware devices—but wherein such devices may be made by potentially different.

In one embodiment, data gathering module 106 may be run periodically to collect and analyze available new data and store it into the database. In this embodiment, the data collected per data source may be gathered:

(1) Via Windows Telemetry and/or Marketing Data:

For example, Devices data: Device HardwareID, Device Manufacturer, Device Type and Description, Device Market Share and specific device capabilities.

Device Drivers: Driver Name and Version, Architecture (32, 64 bit or other), Devices using the specific driver, Market Share of the Driver.

(2) Via Test Management System (TMS):

For example, the following may be gathered: test jobs definitions and categorizations; results from running test jobs (test results) and the devices the jobs were run on; and software defects associated with failed test runs. For merely one example, a suitable test management system (TMS) may be Windows Test Technologies (WTT) or the like.

Before management makes a decision to release software components to the public (e.g., by beta release, general release or the like), it may be desirable to know that a given software component has been tested on a number of such similar devices. It may also be desirable to ensure that certain OS features being implemented in a certain device are being tested. For example, OS and devices work in a collaborated fashion. OS utilizes and uses some of the device capabilities to support their features (for example, low level display API calls device API or sends instruction to device). In addition, a device implements some of the features that OS supports (for example, OS may support high color support. Device may need to support this feature by implementing this High Color feature in their device). Based on this example, it may be desirable to make sure that OS component are being tested across devices and that devices are being verified across supported/implemented features.

In addition, there may be a threshold condition—or a set of conditions—that the system may test for their satisfaction. If there is sufficient satisfaction of conditions, then the system may take an action regarding the release of the software components—e.g., order the release of the software component; or make a recommendation for release of software. In such a case, the system would test a set of conditions—e.g., tha the software performs to some minimum testing condition and/or specification; or on a number of devices that represents a minimum percentage of the market for such devices. System 100 may provide this service and analysis—and present such correlated data and/or metadata at 110 in FIG. 1. Such presentation of data/metadata may be on a display, printed, and/or otherwise electronically delivered.

In one embodiment, the data collected from Windows Telemetry and/or TMS may be provided in the following types of exemplary reports:

(1) Current and historical market share and market share trends data grouped by device, driver, manufacturer and device capabilities. In addition, information regarding new-to-market devices may be desired.

(2) Device and driver test coverage in TMS labs. For example, for every device and driver, a record may be kept showing whether and when the device/driver was available as a test resource in a TMS lab, what kind of tests were performed with them and what was the outcome of these tests.

In addition, the system may make recommendations and/or reports to make decisions—or allow/enable management, engineers and planning staff to answer the following questions and make informant decisions: (1) what are the most popular devices and drivers at the moment and which are expected to gain popularity in the future?; (2) do they have adequate test coverage and test resources to test the behavior of the most popular (current and future) devices and drivers?; (3) are the right tests being run on the right devices/drivers?; (4) in which areas test efforts should be concentrated?; (5) is the quality of our software and device drivers improves over time?; (6) what kinds of software defects are primarily identified?; (7) are the right features working correctly in a certain device?

### Various Embodiments of Data Processing Modules

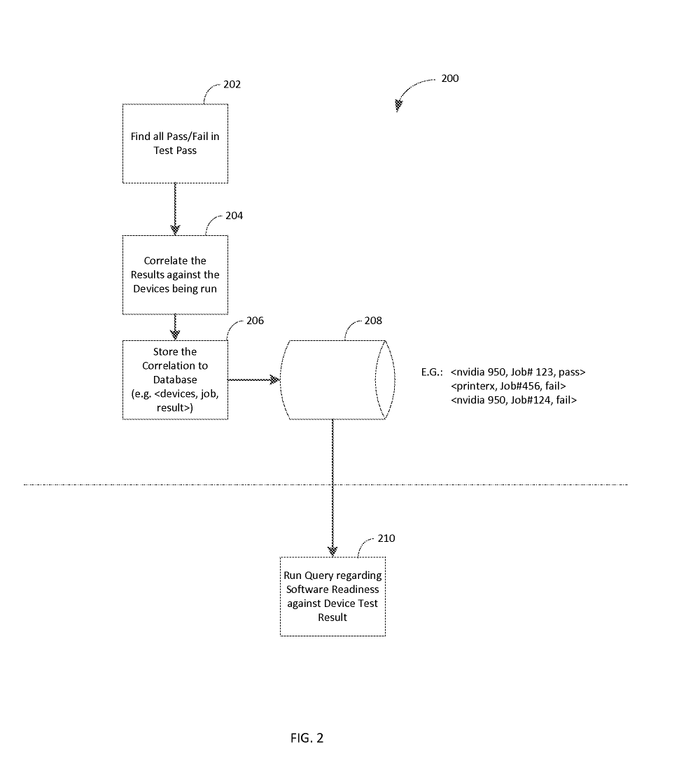

FIG. 2 depicts one embodiment of one aspect of a processing module 200 as made in accordance with the principles of the present application. Processing module 200 may have already gathered test results for a particular software product against a number of hardware devices. In one embodiment, it may be the case that the software has been tested against a number of test suites—e.g., in a number of test runs (possibly indicated as a given job number, as shown in FIG. 2). In another embodiment, the software may be tested against a number of different products that might run the software.

Processing module 200 may find all passes and failures in test runs and/or passes at step 202. Processing module may then correlate the results of passes and/or fails against the plurality of devices being run and/or tested at 204. The correlated results may be stored to electronic store at 206—e.g., a database at 208. The data stored in the database and/or storage may be in the form of a relational database object—e.g., <devices, job, results>,

At some point in time (e.g., contemporaneously or at a later time), processing module 200 may be queried at 210 to provide a report as to the readiness of software in question against a hardware device or a set of hardware devices. The results may encapsulate the test runs—and whether a software component may be released in some manner—e.g., either beta release or general release—could be shown by testing the results against a number of conditions to be considered. For example, a software component may be authorized for release if a threshold (e.g., minimum) number of job runs are PASS for a given device or set of devices. Alternatively, a software component may be withheld for release if a certain threshold (e.g., maximum) number of job runs results in FAIL—and the above conditions for PASS may be accordingly be changed/made relevant for FAIL possibilities. In another embodiment, it is possible to consider the number of PASS/FAIL(s) against a specific hardware with market share data and the device capabilities—which may define the criteria for releasing/not releasing a software component.

In addition, the system may use this correlation data to identify the confidence level of shipping this software across variety of devices. Given that it may not be possible to verify all possible devices, a certain logic may be used to identify a confidence level. For example: (1) software may be verified and reasonably passing for the top 10% market share devices; (2) software may be verified and reasonably passing for the new to market devices; (3) a certain device may be tested and passed against the priority features; (4) a certain device may be tested and work greatly with the common usage applications (e.g., browser, Office, video player, etc.)

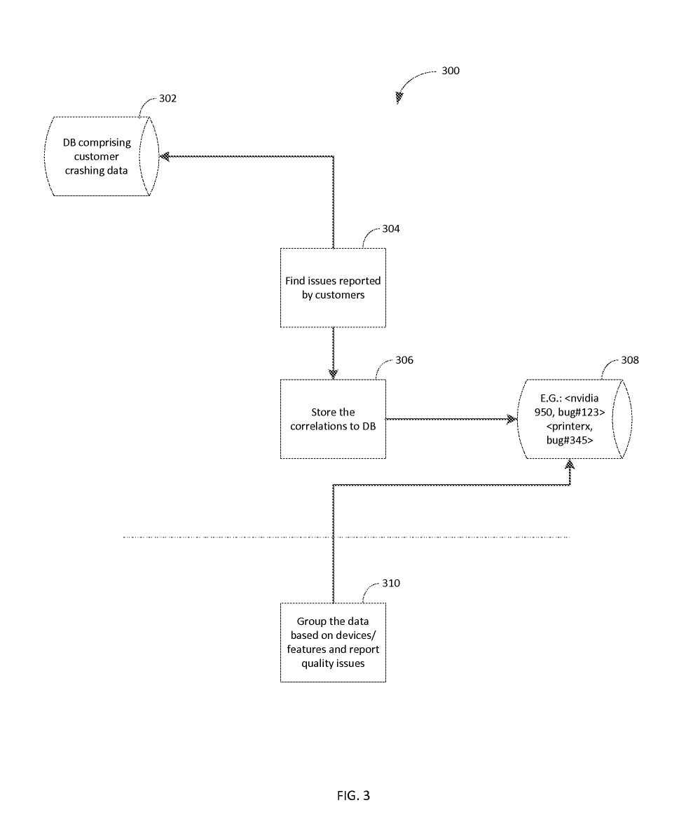

FIG. 3 depicts one embodiment of another aspect of a processing module 300. In this embodiment, a query may be made at 304 to find all quality and/or failure issues reported by customers who may use the software component in question. These failure, quality issues and/or crash data may be stored in a store—e.g., database 302 that may be accessible to relational database queries or the like. Once such a query has been formulated the results may be correlated and stored to the database at 306. These correlated results may be of the form: <device, bug id>—or in any other suitable format. In addition, processing module 300 may group the data based on devices and/or features at 310 and provide a quality issue report. This information may then be used as a good postmortem feedback for software vendor and device partners to reduce the future occurrences of crashes and improve the reliability of the ecosystem.

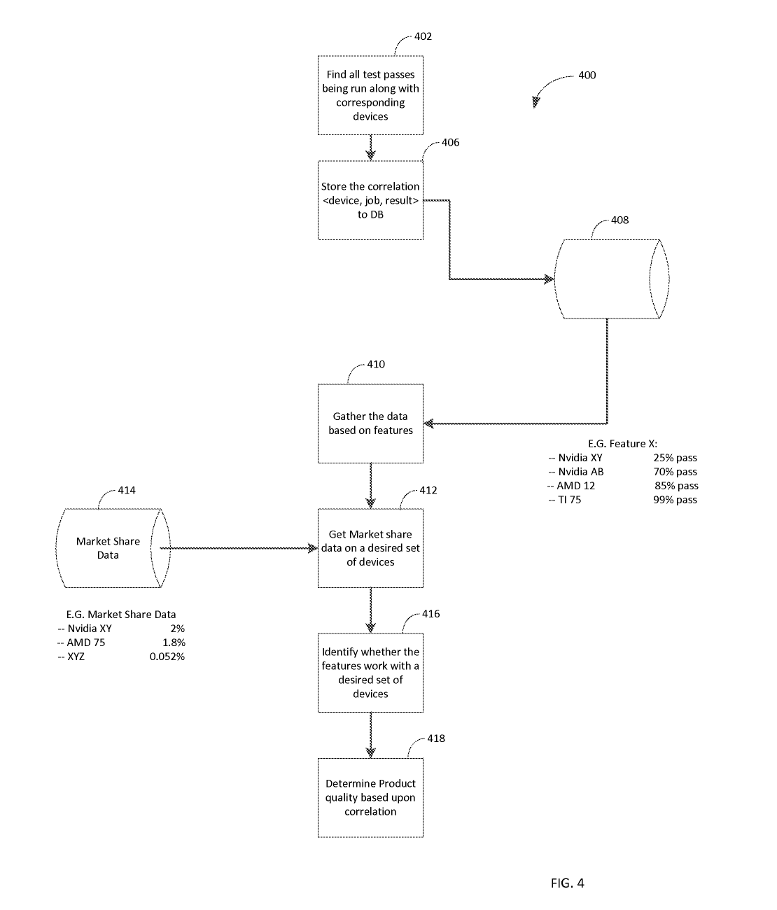

FIG. 4 depicts an embodiment of yet another aspect of a processing module 400. At 402, the processing module may find all test passes that have been run along with corresponding devices. At 406, the results of this query may be correlated and stored in an electronic storage—e.g., database 408. Such a correlation may be of the relational form: <device, job, result>.

At 410, another query may be run to gather the data as it relates to particular features of a software component. For example, for a given feature, X, it may be found that for—e.g., the Nvidia XY device, feature X has passed on 25% of the test runs.

This data may be correlated against market share data (at 412) for e.g., particular devices. For example, it may be noted that a given feature, X, may be possibly available for Nvidia XY, AMD 75 and XYZ devices (NB: these devices are fictitious and/or exemplary merely for the purposes of discussion). Their respective market shares may be correlated then with the pass data, as previously discussed. The processing module may then determine at 416 and 418 how well such features perform to a given market share and product quality may be determined on a per-feature and/or per-market share basis.

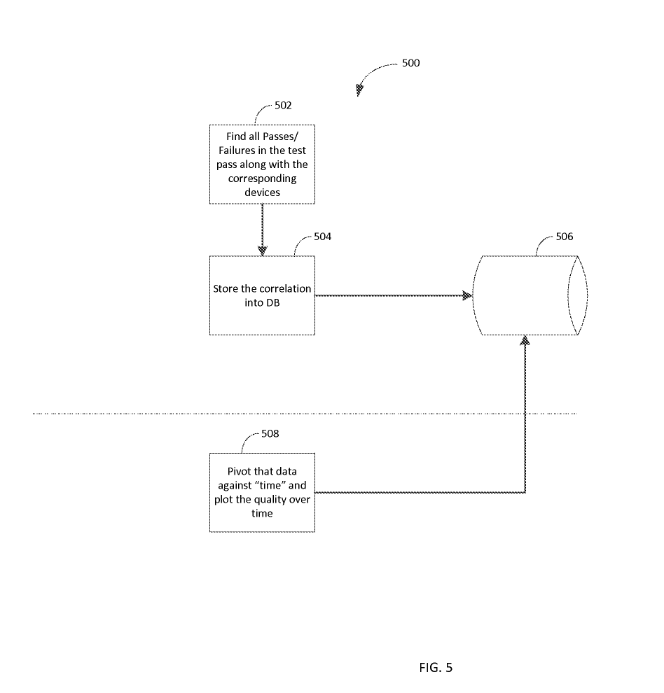

FIG. 5 is one embodiment of another aspect of a processing module 500. At 502, the processing module may find all passes or failures in test runs along with the corresponding devices. At 504, this correlation may be stored in an electronic storage—e.g., a database 506. At a contemporaneous time or at a later time, a query (at 508) may be run that pivots that data against a time axis. In this manner, product quality may be assessed as a function of time.

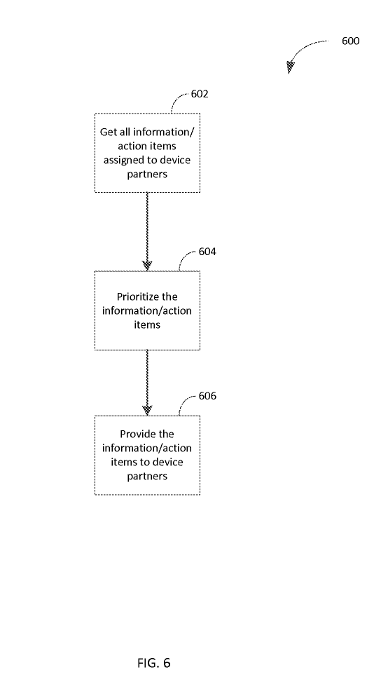

FIG. 6 is one embodiment of yet another aspect of a processing module 600. At 602, a query may be run to find, gather, get or otherwise obtain all or a subset of information and/or action items that are assigned to device partners. In this case, device partners may be certain manufacturers that have agreed in some manner to work cooperatively with the software maker to ensure good product quality for the consumer. At 604, these action items and/or information concerning device partners may be prioritized. At 606, such information and associated analysis on the action items may be shared with the device partners themselves.

For this case, there may be several uses of such information. For example: (1) it may be possible to use the bubbling up of important information related to driver quality to share with the device partners to improve driver quality; and (2) it may be desirable to prioritize information for the device partners as they may be exposed with lots of data and information.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for testing the quality of software components, said software components designed to be executed on at least one hardware device wherein said at least one hardware component capable of being commercially available, the steps of said method comprising:
inputting a set of market data regarding said at least one hardware device;
inputting a set of test results of said software components being tested on said at least one hardware component; and
upon the satisfaction of a set of conditions, taking an action regarding the commercial release of said software components for said at least one hardware component.

2. The method of claim 1 wherein said market data further comprises the share of the market possessed by said at least one hardware device.

3. The method of claim 2 wherein said market data further comprises one of a group, said group comprising: current market share data, historical market share data and new-to-market data.

4. The method of claim 3 wherein said at least one hardware device comprises a plurality of hardware devices for which said software components are designed to be executed.

5. The method of claim 4 wherein the step of inputting a set of market data further comprises:
inputting a set of market data regarding a plurality of devices for which said software components are designed to be executed.

6. The method of claim 5 wherein the step of inputting a set of test results further comprises:
finding all pass/fails results for a set of test runs;
correlating said pass/fail results against said plurality of devices; and
storing the correlation to an electronic storage.

7. The method of claim 6 wherein the method further comprises the step of:
inputting a set of customer data regarding the quality of software execution upon said plurality of devices.

8. The method of claim 7 wherein the method further comprises the step of:
correlating the set of customer data of software reports with a given device.

9. The method of claim 5 wherein said set of conditions further comprises one of a group, said group comprising: a threshold number of passing test runs on a given device, a threshold number of passing test runs for a set of devices, a threshold number of passing test runs for a given market share of devices, a threshold number of passing test runs for a given set of device capabilities.

10. The method of claim 5 wherein said set of conditions further comprises one of a group, said group comprising: a threshold number of failing test runs on a given device, a threshold number of failing test runs for a set of devices, a threshold number of failing test runs for a given market share of devices, a threshold number of failing test runs for a given set of device capabilities.

11. The method of claim 5 wherein the step of taking an action comprises one of a group, said group comprising: ordering the release of said software component, making a recommendation regarding the release of said software component.

12. The method of claim 5 wherein at least one said hardware device is associated with a device manufacturer.

13. The method of claim 12 wherein said device manufacturer comprises a device partner.

14. The method of claim 13 wherein said method further comprises the step of:
finding all information assigned to said device partners;
prioritizing said information; and
providing said information to said device partners.

15. The method of claim 14 wherein said information comprises information related to driver quality.

16. A system for testing the quality of software components, said software components designed to be executed on at least one hardware device wherein said at least one hardware component capable of being commercially available, said system comprising:
a processor, said processor capable of receiving input, wherein said input comprises a set of market data regarding said at least one hardware device and further wherein said input further comprises a set of test results of said software components being tested on said at least one hardware component; and
wherein further said processor is capable of taking an action upon the satisfaction of a set of conditions regarding the commercial release of said software components for at least one hardware component.

17. The system of claim 16 wherein said processor is further capable of:
finding all pass/fails results for a set of test runs;
correlating said pass/fail results against said plurality of devices; and
storing the correlation to an electronic storage.

18. A computer readable storage medium, said computer readable storage medium having computer-executable instructions stored thereon that, when executed by a processor, cause said processor to execute: a method for testing the quality of software components, said software components designed to be executed on at least one hardware device wherein said at least one hardware component capable of being commercially available, the steps of said method comprising:
inputting a set of market data regarding said at least one hardware device;
inputting a set of test results of said software components being tested on said at least one hardware component; and
upon the satisfaction of a set of conditions, taking an action regarding the commercial release of said software components for said at least one hardware component.

19. The computer readable storage medium of claim 18 wherein said step of inputting a set of test results further comprises:
finding all pass/fails results for a set of test runs;
correlating said pass/fail results against said plurality of devices; and
storing the correlation to an electronic storage.

20. The computer readable storage of claim 18 wherein said method further comprises:
inputting a set of customer data regarding the quality of software execution upon said plurality of devices.
